(19) United States
(12) Patent Application Publication
(10) Pub. No.: US 2007/0088467 A1
(43) Pub. Date: Apr. 19, 2007

(54) Integrated system for providing real-time assistance to aircrew

(75) Inventor: Louis H. Knotts, North Tonawanda, NY (US)

Correspondence Address: BOND, SCHOENECK & KING, PLLC, 10 BROWN ROAD, SUITE 201, ITHACA, NY, 14850-1248, US

(73) Assignee: Calspan Corporation

(21) Appl. No.: 11/235,829

(22) Filed: Sep. 27, 2005

(51) Int. Cl. G06F 19/00

(52) U.S. Cl. 701/14; 701/29; 340/961; 342/36

(57) ABSTRACT

The present invention is directed to a virtual copilot system that includes a subscriber aircraft copiloting system configured to obtain at least one aircraft sensor parameter from the aircraft. The copiloting system also is configured to transmit an aircraft identifier and the at least one aircraft sensor parameter via a subscriber data link on a real-time basis. The aircraft copiloting system is further configured to provide two-way voice communications to an on-board user via a predetermined channel. A ground-based communications system includes at least one ground communications component configured to receive the aircraft identifier and the at least one aircraft sensor parameter from the subscriber data link. The ground communications component is also configured to provide voice communications to a ground-based user via the predetermined channel. A computer system is coupled to the ground communications component. The computer system is configured to integrate cockpit instrument panel display data corresponding to the subscriber aircraft and the at least one sensor parameter to obtain a real-time representation of the subscriber aircraft instrument panel. At least one display is coupled to the computer system and configured to display the real-time representation to the ground-based user.

### BACKGROUND OF THE INVENTION

1. Field of the Invention

The present invention relates generally to aviation systems, and particularly to a ground-based advisory system to provide real time assistance to pilots.

2. Technical Background

A pilot or aircrew may become task-saturated and stressed for a variety of reasons. Equipment malfunction, hazy and disorienting conditions, relative inexperience, and adverse weather conditions are some of the reasons that may cause pilot distress. Cockpit emergencies are usually not the result of a single isolated event, but come about because of a series of events and decisions that occur over an extended period of time. Some individuals react slowly and do not perform their tasks adequately when they find themselves in an emergency situation. They often fail to prioritize and neglect to do the most obvious things. As the stress increases, the pilot's effectiveness may decrease proportionately. A snow balling effect may occur as one bad decision follows another. The challenge for the pilot and/or aircrew is to react and make the proper decision in response to each event. However, when problems occur at a rapid rate, it may become difficult for the pilot and/or aircrew to react in an appropriate and timely manner. In other words, the pilot/aircrew become task saturated.

For example, it is well known that spatial disorientation resulting from Visual Flight Rules (VFR) flight into adverse weather conditions is a regular cause of fatal aircraft accidents. In another example, a night time descent over water in dark and hazy conditions also may result in spatial disorientation. In such cases, inexperienced pilots may not trust their instruments and decide to trust their instincts, often with fatal results. In yet another example, an experienced pilot and/or aircrew may be faced with an equipment malfunction that requires an emergency landing. These situations are particularly frequent when pilots are flying in a single pilot aircraft and do not have the assistance of a knowledgeable aviator to assist with the aircraft control tasks, navigation, communication, and other procedures required to safely land the aircraft.

On the other hand, a catastrophe may be averted if the pilot and/or aircrew has access to assistance from a ground-based advisor that is fully apprised of the challenges facing the aircraft. Accordingly, what is needed in each of these situations is a trained ground-based advisor that fully understands the aircraft's operational status and is in two-way communication with the crew. Referring to the first two examples provided above, a system is needed that would provide an advisor with the means to knowledgably talk the pilot through the proper procedures for executing a safe approach and landing. In the last example, a system is needed that would provide an advisor with the means to knowledgably direct the aircrew to a nearby airport or airfield. To put it more succinctly, what is needed is a real-time virtual co-piloting system that may be easily accessed by a pilot and/or aircrew to help them arrive safely at their destination. SUMMARY OF THE INVENTION

The present invention addresses the needs described above. The present invention is directed to a virtual co-pilot system that provides a pilot or aircrew with informed real-time assistance. The present invention provides a ground-based advisor with a full operational understanding of the aircraft's status, allowing the advisor to provide informed assistance to the crew by way of a two-way communication system.

One aspect of the present invention is directed to a virtual copilot system that includes a subscriber aircraft system configured to obtain at least one aircraft sensor parameter from the aircraft. The system also is configured to transmit an aircraft identifier and the at least one aircraft sensor parameter via a subscriber data link on a real-time basis. The aircraft system is further configured to provide two-way voice communications to an on-board user via a predetermined channel. A ground-based system includes a ground communications component configured to receive the aircraft identifier and the at least one aircraft sensor parameter from the subscriber data link. The ground communications component is also configured to provide voice communications to a ground-based user via the predetermined channel. A computer system is coupled to the ground communications component. The computer system is configured to integrate cockpit instrument panel display data corresponding to the subscriber aircraft and the at least one sensor parameter to obtain a real-time simulation of the subscriber aircraft instrument panel. At least one display is coupled to the computer system and configured to display the real-time simulation to the ground-based advisor.

In another embodiment, the present invention is directed to a method for providing assistance from a ground-based system to an aircrew disposed on a subscriber aircraft. The subscriber aircraft is equipped with an aircraft instrumentation panel. The method includes transmitting an aircraft identifier and at least one sensor parameter from the subscriber aircraft to the ground-based system on a real-time basis. Cockpit instrument panel data is provided to the ground-based system, the cockpit instrument panel data corresponding to the aircraft identifier. The cockpit instrument panel data and the at least one sensor parameter are integrated to obtain a real-time status of the subscriber aircraft instrumentation panel in real-time. The real-time status is displayed to a ground-based user. A two-way voice communication channel is established between the aircrew and the ground-based user, whereby the ground-based user provides co-piloting services to the aircrew via the two-way voice communication channel based on the displayed real-time status.

In yet another embodiment, the present invention is directed to a subscriber aircraft copiloting system that includes an aircraft systems interface configured to obtain aircraft sensor parameters from the aircraft. The sensor parameters include a subscriber aircraft position, a subscriber aircraft pitch attitude, a subscriber aircraft roll attitude, a subscriber aircraft airspeed, a subscriber aircraft altitude, and/or a subscriber aircraft heading. A data transmission facility is configured to transmit an aircraft identifier and the aircraft sensor parameters to a ground-based station on a real-time basis via a subscriber data link, wherein the subscriber data link transmits the aircraft sensor parameters at a 1 Hz rate. A voice communications system is configured to provide two-way voice communications between an on-board user and a ground-based user via a predetermined channel.

In yet another embodiment, the present invention is directed to a ground-based copiloting system that includes a ground-based communications system (GBCS) configured to receive an aircraft identifier and aircraft sensor parameters from a subscriber aircraft by way of a subscriber data link. The GBCS is also configured to provide voice communications between a ground-based user and a user aboard the subscriber aircraft via a predetermined channel. A computer system is coupled to the GBCS, the computer system being configured to integrate cockpit instrument panel display data corresponding to the subscriber aircraft and the aircraft sensor parameters to obtain a real-time representation of the subscriber aircraft instrument panel. At least one display is coupled to the computer system and configured to display the real-time representation to the ground-based user.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a diagram of the virtual co-piloting system in accordance with the present invention;

FIG. 2 is a block diagram of a subscriber aircraft co-piloting system component in accordance with an embodiment of the present invention;

FIG. 3 is a block diagram of a ground-based co-piloting system component in accordance with an embodiment of the present invention;

FIG. 4 is a flow chart illustrating a method of the subscriber aircraft co-piloting system component shown in FIG. 2;

FIG. 5 is a flow chart illustrating a method of the ground-based co-piloting system component shown in FIG. 3;

FIG. 6 is an example of a ground-based simulated instrument panel display in accordance with an embodiment of the present invention; and

FIG. 7 is an example of a ground-based mapping display in accordance with an embodiment of the present invention.

### DETAILED DESCRIPTION

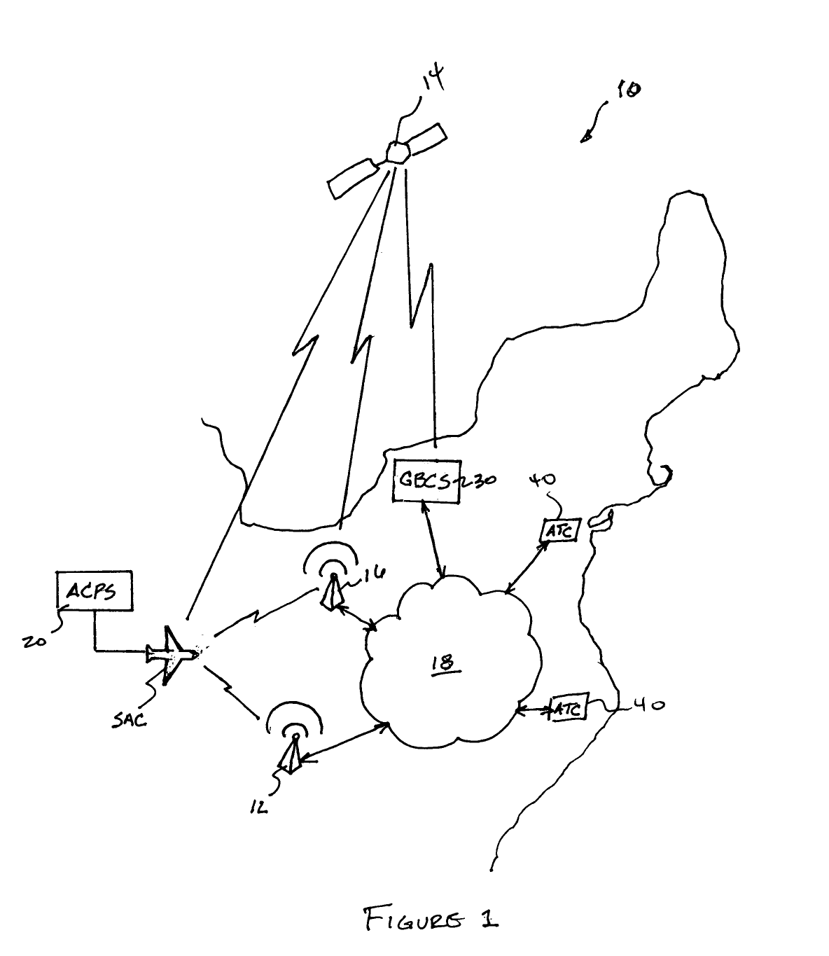

Reference will now be made in detail to the present embodiments of the invention, examples of which are illustrated in the accompanying drawings. Wherever possible, the same reference numbers will be used throughout the drawings to refer to the same or like parts. An exemplary embodiment of the system of the present invention is shown in FIG. 1, and is designated generally throughout by reference numeral 10.

As embodied herein, and depicted in FIG. 1, a diagram of the virtual copiloting system 10 in accordance with the present invention is disclosed. In the example of FIG. 1, one of more subscriber aircraft (SAC) are shown flying over a portion of the North American continent. Each SAC includes an aircraft copiloting system (ACPS) 20 in communication with ground-based control system (GBCS) 30 via various types of two-way communication methods. For example, ACPS 20 is shown communicating with GBCS 30 by way of radio communications system 12, satellite communication system 14, and/or wireless communication system 16. The radio communications system 12 and the wireless communication system 16 are coupled to communication network 18. Also, satellite communication system 14 may be coupled to wireless network system 16 as well. GBCS 30 is coupled to communication network 18 and satellite network 14. GBCS 30 may communicate with air traffic control facilities (ATC) 40 by way of network 18.

It will be apparent to those of ordinary skill in the pertinent art that modifications and variations can be made to ACPS 20 of the present invention depending on the cost and sophistication of the on-board equipment package. For example, ACPS 20 may be configured to communicate with GBCS via HF/UHF/VHF analog radio, wireless/cellular telephony, air phone, digital radio, wi-fi, digital satellite radio, and/or any other wireless communication method. Those of ordinary skill in the art will understand that system 10 may employ any one of the communication systems (12, 14, 16, 18) alone, or in combination, in providing voice and data communications between ACPS 20 and GBCS 30.

Radio system 12 is configured to transmit and receive voice and data to/from ACPS 20 by way of radio signals. In one embodiment, radio system 12 is implemented as an analog system that includes one or more facilities configured to transmit/receive via HF/UHF/VHF analog radio. For example, radio system 12 may be configured to transmit/receive voice and data by way of AM or FM radio transmission facilities. Radio system 12 may also be configured to transmit and receive digital audio signals in the S band (approved for use in the U.S.) and L band (used in Europe and Canada). Radio system 12 may also include a digital radio broadcasting system that is employed as a signal repeater for satellite system 14.

Digital radio communications may also be established by implementing a time division multiple access (TDMA) frame format or a code division multiple access (CDMA) format, both of which may be configured to accommodate both voice and data in a single data structure. The present invention may be implemented using the global system for mobile communication (GSM) or spread spectrum techniques may also be employed. In other words, a wide variety of aircraft systems 20, while differing in sophistication because of the differing communication formats, may take full advantage of the system. The present invention may also be adapted to any new form of communication technologies that may develop over time. These technologies may employ electromagnetic waves, such as radio frequency (RF), optical and etc. GBCS 30, on the other hand, is configured to accommodate all of the various communication equipments. As new technologies develop and come on-line, GBCS 30 will be modified and adapted to accommodate these technologies.

Those of ordinary skill in the pertinent art will understand that any suitable type of wireless network 16 may be used to implement voice and data communications between ACPS 20 and GBCS 30. For example, wireless network 16 may be a wireless communications carrier such as a mobile cellular telephone system that is adapted to transmit and receive signals to/from one or more ACPS 20. Wireless communication system 16 may incorporate any type of wireless telecommunication network in which electromagnetic waves propagate voice and data signals over at least a portion of the communication path between the ACPS 20 and the GBCS 30. Wireless network 16 may be an analog mobile telephone system operating over existing mobile frequency bands, such as those operating at or near 800 MHz. In another embodiment, the wireless network 16 providing all or a portion of the communication path between the ACPS 20 and the GBCS 30 may be a digital mobile telephone system. Those of ordinary skill in the art will understand that these wireless networks may operate over pre-existing channels in the 800 MHz, 900 MHz, and/or 1900 MHz regions of the frequency spectrum. On the other hand, any suitable band capable of carrying mobile communications may be employed in implementing the present invention. Those skilled in the art will also recognize that wireless network 16 may be configured to provide short messaging services, based on established protocols such as IS-637 SMS standards, IS-136 air interface standards for SMS, and GSM 03.40 and 09.02 standards. Wireless network 16 may also be compliant with other systems types, such as 802.11 (e.g., wi-fi) compliant systems and Bluetooth systems. Wireless network 16 may also be configured to operate using a Dedicated Short Range Communications standard (DSRC).

Those of ordinary skill in the pertinent art will understand that any suitable type of satellite communication network 14 may be used to implement voice and data communications between ACPS 20 and GBCS 30. In one embodiment, satellite system 14 may operate over pre-existing channels in the 2.3 GHz region of the frequency spectrum (S-band). This portion of the spectrum has been allocated by the U.S. Federal Communications Commission (FCC) for nationwide broadcasting of satellite-based Digital Audio Radio Service (DARS).

Again, those of ordinary skill in the pertinent art will understand that communications network 18 may be comprised of any suitable means for coupling radio network 12 and/or wireless network 16 to GBCS 30. As such, network 18 may, in fact, be comprised of a single network system or a combination of network systems. For example, communications network 18 may include a mobile switching center and provide voice and data services from one or more wireless communications companies. As those of ordinary skill in the art will understand, wireless networks are coupled to wire line networks to provide seamless communications between a wireless telephony set and a wire line telephony set. Of course, the wire line voice and data communications may be supported by way of a circuit-switched networks such as the public-switched telephone network (PSTN), cable-television networks, packet switched networks and/or any combination thereof. Examples of a packet switched network include internet protocol (IP) networks. Those skilled in the pertinent arts will also understand that network 18 may be implemented using legacy copper-cable systems, fiber-optic based systems, optical networks, other wireless networks, and/or any combination thereof. As alluded to previously, system 10 of the present invention may employ all or part of radio network 12, satellite network 14, wireless network 16, as well as communication network 18 in providing voice and data communications between ACPS 20 and GBCS 30.

Of course, GBCS 30 is implemented as a call center, as known in the art. In an example, GBCS 30 is implemented as a voice call center, providing verbal communications between an advisor in the call center and a subscriber aircraft.

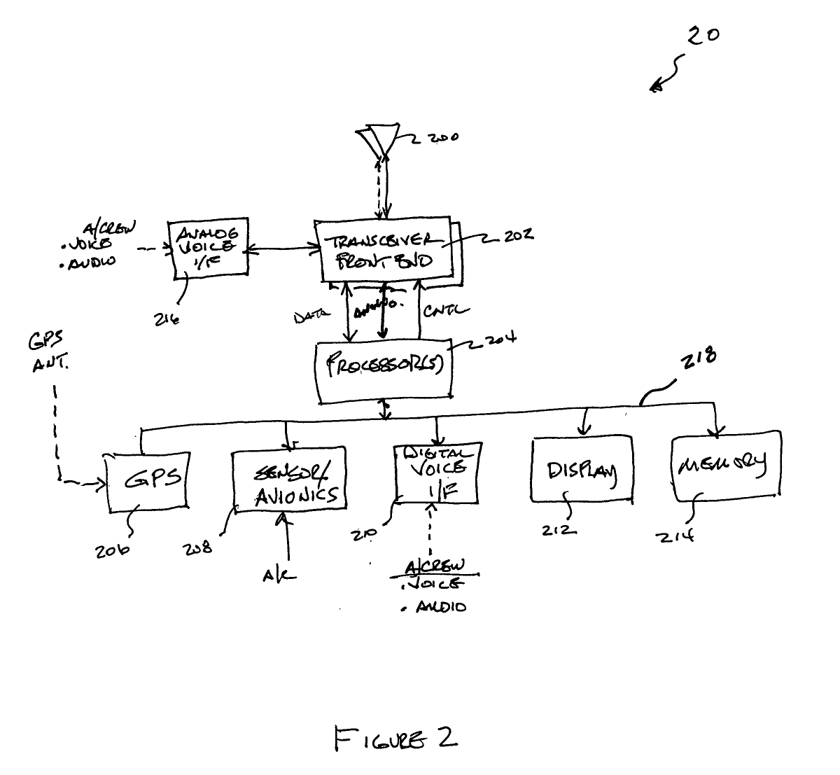

As embodied herein and depicted in FIG. 2, a block diagram of a subscriber aircraft copiloting system 20 depicted in FIG. 1 is disclosed. Subscriber aircraft-copiloting system 20 includes antenna(s) 200 coupled to RF transceiver(s) 202. As FIG. 2 suggests, system 20 may require multiple antennas 200 and/or transceivers 202 depending on how system 20 is implemented. As noted previously, the present invention may be implemented using analog radio, digital radio, wireless/cellular telephony and/or by satellite communication technology. Thus, for example, an analog radio voice channel and a digital data link may require separate RF transceivers and antennas.

Referring back to FIG. 2, transceiver 202 is coupled to processor unit 204. With regard to the content of the data link, GPS unit 206 provides processor unit 204 with GPS aircraft position data by way of data bus 218. Sensor unit 208 is coupled to various sensor and aircraft sub-system monitoring units disposed at various locations in the subscriber aircraft. Sensor unit 208 converts these inputs into a digital format and transmits the sensor data to processor 204 with at least a 1 Hz rate. In other words, sensor data is updated at least once a second. The data transmit rate may vary more or less from the aforementioned 1 Hz rate depending on the specific data parameter (i.e., position, altitude, pitch, roll, fuel status, and etc.) and the bandwidth of the communication medium, but as those of ordinary skill in the art will understand, a 1 Hz rate should be considered an acceptable data rate.

If a one-way data link is implemented, system 20 may be configured to broadcast aircraft parameters over a predefined channel. Link operability may be confirmed by way of voice communications. When system 20 employs a two-way link, ground system 30 may be configured to interrogate system 20 using the link. This approach allows the ground-based advisor to obtain more information from the aircraft without further burdening the task-saturated crew. For example, the advisor may employ a user-interface to transmit diagnostic codes to the aircraft to gain a better understanding of the aircraft status. This status information may better inform the advisor of the aircraft's capabilities.

Two-way digital voice is provided to processor unit 204 by digital voice interface 210 via data bus 218. System 20 may include a display configured to provide the pilot and/or aircrew with system status information. Finally, memory 214 is coupled to processor unit 204. Alternately, memory 214 may be incorporated with the processors 204. As noted above, the present invention is quite versatile in that voice communications may be implemented in a variety of ways. In an analog radio implementation, transceiver 202 may receive an analog base band signal from either processor unit 204 or from analog voice interface 216, depending on the implementation of system 20. In the simplest approach, two-way analog voice communications may be implemented directly using analog interface 216. If the system does not include interface 216 and the standard HF/UHF/VHF analog radio is employed, processor unit 204 includes both D/A converters and A/D converters to effect the two-way analog/digital conversions. Alternatively, if digital radio is used, digital voice and data may be exchanged between processor unit 204 and transceiver 202.

A high level description of system 20 has been provided in the preceding paragraphs. A more detailed description of the system 20 components is provided below, along with their alternative embodiments.

In one embodiment, voice interface (210/216), processor 204, transceiver 202, and antenna 200 are implemented using an analog or digital phone with suitable hardware and software for transmitting and receiving data communications. Transceiver 202 may also be equipped with a wireless modem for transmitting and receiving data. Of course, processor may be implemented using a digital signal processor with software and additional hardware to enable communications between ACPS 20 and wireless network 16. Wireless communications employing code division multiple access (CDMA) technology may also be employed by the present invention.

Transceiver 202 may also be implemented using a standard VHF radio that may be used by the aircrew to establish two-way voice communications with GBCS 30. This implementation takes advantage of the fact that civilian aircraft often operate in the VHF band. On the other hand, military applications or those applications that include both military and civilian units may operate in the UHF bands. Other applications employ HF bands. Accordingly, transceiver 202 may also employ HF or UHF radio systems compatible with such applications. In alternate implementations of the present invention, transceiver 202 may be configured to communicate in all three (and other) frequency bands to provide redundancy.

The operation of standard analog HF/UHF/UHF radio voice communications is well known in the art. Many HF/UHF and/or VHF radios provide voice communications using AM, FM or variants thereof (SSB, VSB, DSBSC, and etc.). On the receiver side, an RF signal is directed from the antenna 200 into a low noise amplifier (LNA) and a band pass filter before being demodulated by the receiver. Of course, the demodulation is carried out in accordance with the modulation format employed by system 10.

If standard HF/UHF/VHF radios are used to implement voice communications, transceiver 202 must also include data link transceiver equipment for sending and receiving data via a data link between the aircraft and GBCS 30. In an alternate embodiment of the present invention, the data link may be implemented by way of a one-way link from the aircraft 20 to GBCS 30. The data link may employ a digital encoding technique such as pulse code modulation (PCM). Of course, analog encoding techniques, such as amplitude, frequency, and phase modulation may also be employed. Standard modulation techniques for voice/audio communications were identified above. Band pass data transmissions may be implemented using any suitable technique such as ASK, FSK, PSK, QPSK, etc.

In another embodiment of the present invention, transceiver 202 may be implemented as part of a digital radio. The digital radio of the present invention may support any modulation scheme, or combination of formats, for supporting both voice communications and data communications. Of course, a good part of the functionality of the digital radio is implemented in software residing in processor unit 204.

As noted above, voice and data communications may be implemented in a unified digital format. One way to accomplish this is by employing a frame structure. System 20 may be configured to decode a synchronization pattern from a GBCS 30 transmission. Once in synchronization, two way communications are maintained by way of a time-division multiplexed frame structure that includes a voice payload and data payload. In practice, processor unit 204 decodes a GBCS preamble that is used to provide timing for every bit position in the GBCS 30 data burst. In similar fashion, system 20 responds with a similarly formatted data frame. GBCS decodes the preamble and recovers voice and sensor data based on their position with the system 20 data burst. This implementation may be advantageous in a satellite system covering a wide geographical area. As those of ordinary skill in the art will understand, a satellite communication network may be advantageous because it eliminates many of the problems associated with line-of-sight radio systems.

Referring to processing block 204 in FIG. 2, depending on the complexity of the system 20 implementation, processing may be implemented using a single processor or may include multiple processors. For example, processor unit 204 may be implemented using both a system processor as well as one or more digital signal processors (DSPs). The system processor is typically configured to support the system 20 operating system and manage the application software. The system processor may be implemented using any suitable processor device, such as those manufactured by Intel, Inc. AMD, Inc., or others. Any suitable DSP processor may be used, consistent with the signal processing requirements of the present invention. As those of ordinary skill in the art will understand, many signal processing functions may be implemented more efficiently using DSP techniques. For example, FFTs and digital filtering are easily implemented in DSP devices. The present invention may be implemented, for example, by DSP devices manufactured by Motorola, Analog Devices, Texas Instruments, as well as other suitable DSP device manufacturers. In another embodiment, the DSP functionality is implemented using “PowerPC” processors.

Memory 214 includes both random access memory (RAM), read only memory (ROM), as well as any computer-readable media. The term “computer-readable media” as used herein refers to any medium that may be used to provide data and instructions to processor(s) 204. Computer readable media may be implemented in many different forms, including but not limited to non-volatile media, volatile media, and/or transmission media. As those of ordinary skill in the art will understand, RAM is configured to store system data, digital audio, sensor data, status information, instructions for use and execution by the processors, and temporary variables or other intermediate data used by the processor while executing instructions. ROM, or other static storage devices, may be employed to store programming instructions for the processor. Those skilled in the art will also understand that ROM may be implemented using PROM, EPROM, E²PROM, FLASH-EPROM and/or any other suitable static storage device. Any other memory chip or cartridge may be used as well. Other forms of computer-readable media include floppy-disks, flexible disks, hard disks, magnetic tape or any other type of magnetic media, CD-ROM, CDR/W, DVD, as well as other forms of optical media such as punch cards, paper tape, optical mark sheets, or any other physical medium with hole patterns or other optically recognizable media. The present invention also defines any wireless or wired media from which a computer may access as computer-readable media.

Interface 216 typically includes audio speakers, a microphone, a voice output, an audio channel, and performs any buffering, amplification, or filtering required by audio channel. Of course, in addition to digitizing analog voice and converting digital data into analog electrical voice signals, digital voice unit 210 performs many of the same buffering and amplification functions provided by analog voice interface 216 including the synthesizing of the voice. Of course, if voice communications and sensor communications are combined in a multiplexed format by processor unit 204, analog voice interface 216 would not be an option since the data line between processor 204 and transceiver 202 would include both digital voice data as well as digital sensor data.

Those skilled in the art will also understand that transmission media employed between any of the units depicted in FIG. 2 may include coaxial cables, computer backplane interfaces, copper wire and/or fiber optic transmission media. Further, transmission media may be implemented using acoustic, optical, or other electromagnetic waves, such as those generated by radio frequency (RF) and infrared data communications components.

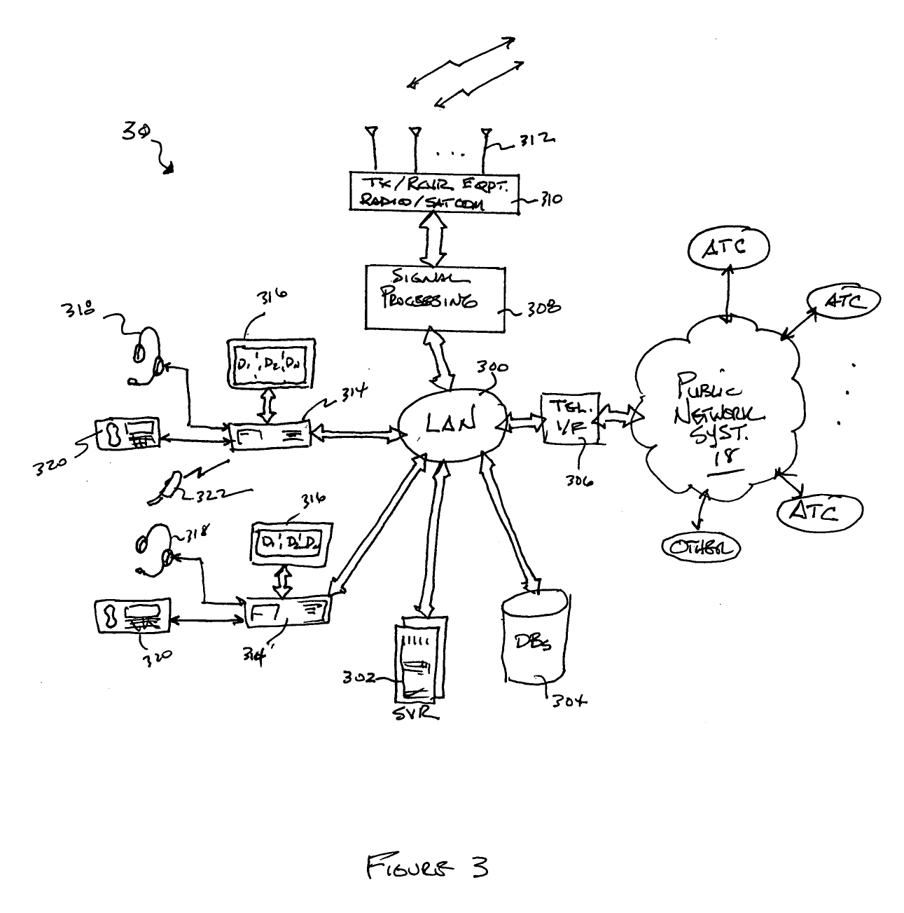

As embodied herein and depicted in FIG. 3, a block diagram of a ground-based copiloting system (GBCS) 30 in accordance with an embodiment of the present invention is disclosed. In one embodiment, GBCS 30 may include a local area network (LAN) 300 configured to distribute computing resources to several advisor workstations 314. LAN 300 is managed by server computer 302. Server may reside in a workstation computer and vice-versa. GBCS 30 also includes several databases 304. Databases 304 include a subscriber aircraft cockpit simulation database, a geographical/mapping database, and a database of aircraft procedures to name a few. LAN 300 may be coupled to an external network system by way of interface 306. Those skilled in the art will also understand that LAN network 300 may also be implemented as a wide area network (WAN).

A ground-based advisor may communicate with subscriber aircraft system 20 by way of workstation 314 and headset 318. Each work station 314 is coupled to a display system 316. Headset 318 is coupled to workstation 314 by way of an interface card disposed in workstation 314. The headset provides an audio interface with the voice communications channel established between GBCS 30 and subscriber aircraft 20. Workstation 314 is also coupled to telephony handset 320. The telephony headset 320 provides the ground-based advisor with the ability to communicate with air traffic control. Workstation 314 is also configured to patch air traffic control (ATC) 40, headset 318 and subscriber system 20 in a teleconferencing mode that enables N - way conversation including the aircrew/pilot, the advisor(s), and ATC, wherein N is an integer value. Voice communications are directed from the interface card disposed in workstation 314 to processing unit 308 via LAN 300. In the opposite direction, voice and sensor data are directed from processing unit 308 to the appropriate workstation 314.

With regard to signal processing unit 308 and transceiver equipment 310, the various aircraft subscribing to system 10 may employ different voice and data communication packages because of cost and design issues. As noted above, smaller and less expensive aircraft may use analog HF/UHF/VHF radio to implement voice communications. Another more sophisticated subscriber aircraft system 20 may employ the integrated digital voice and data approach. Yet another may employ a satellite communications channel for both voice and data. Signal processing unit 308 and RF transceiver equipment 310 must accommodate all of the aforementioned systems. Because the transceiver and processing systems were described in the discussion of system 20, any further discussion would be redundant and unnecessary. Of course, the ground-based advisor disposed on workstation 314 and communicating by way of headset 318 may also communicate with the ACPS 20 via interface 306.

As shown in FIG. 3, interface 306 provides ground-based advisors with a telephonic/data connection to ATC 40, radio network 12, and/or wireless system 16 by way of network 18. Network system 18 was described in detail above, and as noted therein, may be implemented using the public switched telephony network (PSTN), an Internet backbone, a packet switched network, a wireless telephony system, and/or any combination thereof.

Work station 314 includes a processor unit coupled to a data bus system. Those skilled in the art will understand that some or all of the signal processing functionality in system 30 may be distributed among the workstations 314. As such, workstation may include a processor programmed to support an operating system and application programming as well as a DSP device for performing signal processing. The data bus system is configured to transmit address, data, and control information to other processing components disposed in the work station 314. Work station 314 includes random access memory (RAM), or other dynamic storage devices, coupled to the data bus. The RAM is used to store data and instructions for execution by the processor. RAM may also be used for storing temporary variables or other intermediate information during execution of instructions by the CPU. The work station computer system may further include read only memory (ROM) or other static storage devices. Once again, those skilled in the art will also understand that ROM may be implemented using PROM, EPROM, E²PROM, FLASH-EPROM and/or any other suitable static storage device. Storage devices such as a magnetic disks or optical disks may also be included.

Workstation typically includes input devices such as a keyboard, mouse, and/or trackball. The keyboard, of course, includes alphanumeric keys as well as cursor control keys, as commonly found on personal computers. The input devices, of course, are used to communicate information and command selections to the processor unit in workstation 314.

Each work station 314 typically includes a communication interface coupled internally to the data bus. The communication interface provides a two-way data communication with LAN/WAN 300. The communication interface may typically be a local area network (LAN) card (e.g. for Ethernet™ or an Asynchronous Transfer Model (ATM) network) configured to provide a data communication connection to a compatible LAN. As another example, the communication interface may be a digital subscriber line (DSL) card or modem, an integrated services digital network (ISDN) card, a cable modem, a telephone modem, or any other communication interface to provide a data communication connection to a corresponding type of communication line. Wireless links may also be implemented. In any such implementation, the communication interface transmits and receives electrical, electromagnetic, or optical data signals. The communication interface may also include peripheral interface devices, such as a Universal Serial Bus (USB) interface, a PCMCIA (Personal Computer Memory Card International Association) interface, etc. Although the aforementioned description refers to a single communication interface, multiple communication interfaces may be employed herein.

Display 316 may be implemented using a cathode ray tube (CRT), liquid crystal display, active matrix display, plasma display, or digital light processing (DLP). As shown in FIG. 3, display 316 is configured to provide the ground-based advisor with up to N-displays, D1, D2, . . .Dₙ. In one embodiment, N=3, and display 316 provides the user with cockpit simulation display, a geographical situation display, and a display of subscriber aircraft procedures. In another embodiment, display 316 may be used to provide the advisor with a display of area weather conditions. Those of ordinary skill in the art will understand that the present invention should not be construed as being limited to the aforementioned display options. Because of GBCS 30 access to multiple data inputs, i.e., external networks, radio input, satellite communication channels, display 316 may be employed to provide the advisor with any relevant information as needed. The various displays may be provided by a Windows ™ based operating system that includes multiple applications that run simultaneously, pop-up displays, drop down menus, and/or any other suitable display means.

Telephone sets 320 may be of any suitable type including the traditional wire line telephone sets, cordless telephone sets, and/or voice over internet protocol (VoIP) sets.

The network interface 306 may be implemented as a PBX or by way of a telephony gateway. Interface 306 may also be configured to provide both voice and data communication between workstations 314 and telephone sets 320, and one or more networks for communication with remote devices. For example, the network link 306 may provide a connection between a workstation 314 and a wide area network (WAN), or the global packet data communication network now commonly referred to as the “Internet”, by way of LAN 300.

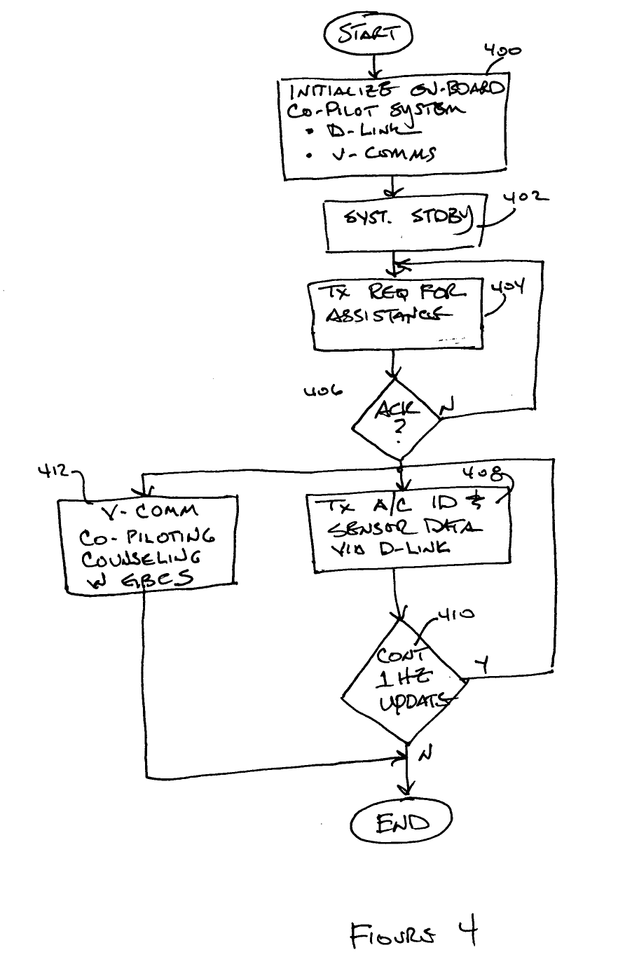

Referring to FIG. 4, a flow chart illustrating a method of operating the subscriber aircraft copiloting system 20 shown in FIG. 2 is disclosed. In step 400, the aircrew of pilot initializes the on-board co-pilot system 20 as part of the pre-flight routine. As illustrated in FIG. 1, the frequency of the voice communication channel as well as the data channel may be predicated by the geographical area(s) traversed by the flight path. This information of course would be communicated by the administrators of system 10 to the aircrew in advance of the flight. After system 20 is initialized, it may be placed in a standby mode until needed.

In step 404, system 20 is turned ON and a request for assistance is transmitted to the GBCS 30 by way of the data link. The signal processing unit 308 in the GBCS interprets the message as a request for assistance and directs the request to an available workstation 314. If the data link is a two-way link, processing unit 308 may be programmed to provide an acknowledge signal back to system 20. In this case, system 20 is configured to retransmit the request for assistance until an acknowledge signal is provided by the GBCS. Once received, the acknowledgement may be provided to display 212 as a visual or audible acknowledgement to the aircrew. If system 20 supports a one way data link, processing proceeds to step 408.

In step 408, processor unit 204 (FIG. 2) obtains positional data from GPS unit 206 and aircraft sensor data from unit 208. As noted previously, the data includes altitude, airspeed, pitch, roll, aircraft position, as well as other data. For example, in more sophisticated systems, unit 208 may be configured to monitor fuel levels, aircraft subsystem performance data, and alarm data. This data is packetized and transmitted by transceiver 202 via antenna 200. This process is repeated automatically and continuously at a 1 Hz minimum data rate. In the meantime, the pilot and/or aircrew is receiving counseling from at least one ground-based advisor via the voice communication channel. As noted above, the ground-based advisor may interrogate ACPS 20 to get a more detailed operational status of the subscriber aircraft.

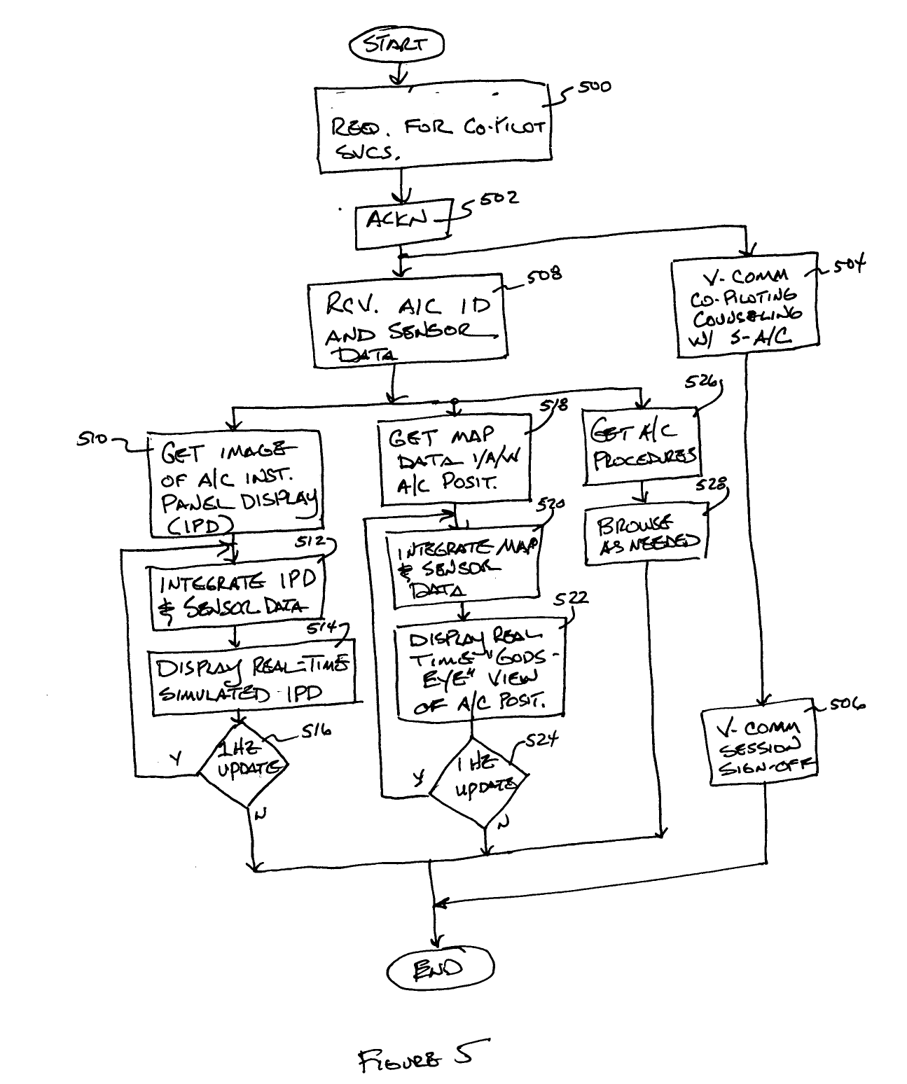

Referring to FIG. 5, a flow chart illustrating a method of operating the ground-based copiloting system 30 is disclosed. In step 500, GBCS 30 receives a request for assistance from a subscriber aircraft via the data link. After acknowledging receipt of the request (in a two-way data link), the GBCS processor unit recovers the subscriber aircraft identifier and the initial sensor data in step 508. As noted above, this information, along with the aircraft identifier and sensor data, are directed to an available workstation 314. The workstation software is programmed to give the operator/advisor a heads-up via display 316 and/or an audible alarm directed into headset 318. Processor unit 308 is also configured to patch headset 318 into the appropriate voice communication channel. At this point, the ground-based advisor begins voice communications with the pilot and/or aircrew of the subscriber aircraft.

Simultaneous with step 504, the workstation processor provides the subscriber aircraft database (shown generally in FIG. 3 as data base 304) with the subscriber aircraft identifier. The database relates this identifier to an aircraft type representing an aircraft classification of the subscriber aircraft. The aircraft type data is, in turn, related to a cockpit instrument panel display (IPD). As such, an image of the cockpit instrument panel display corresponding to the aircraft classification stored in the database is retrieved in step 510. In step 512, the workstation processor integrates the retrieved instrument panel display (IPD) and the sensor data, and displays the integrated data on display 316. Display 316 (i.e., one of D1 . . . Dₙ) provides a replica of the subscriber instrument panel with the actual readings of the aircraft's attitude, heading, altimeter, and position. The display of the subscriber instrument panel is updated at a minimum 1Hz rate.

Again, virtually simultaneous with step 504, the workstation processor obtains a digital map from a geographical database (shown generally in FIG. 3 as data base 304) based on the position provided by the subscriber aircraft. The map may include terrain features, navigational aids, and airport location data. In step 520, the workstation 314 integrates the aircraft position data with the digital map obtained in step 518. In step 522, a real-time “God's eye” view of the aircraft position is displayed on display 316. In particular, display 316 (i.e., one of D1 . . . Dₙ) shows an aircraft symbol showing the aircraft heading, altitude, ground track, and any other useful data superimposed over the digital map. In an alternate embodiment, the length of a portion of aircraft heading symbol may be proportional to the airspeed. Of course, those of ordinary skill in the art will understand that the data format used to display subscriber aircraft information may be of any suitable type to optimize the situational awareness of the ground advisor.

In step 526, yet again virtually simultaneous with step 504, the workstation processor obtains electronic checklists of various subscriber aircraft procedures from a procedure database (again, shown generally in FIG. 3 as data base 304). In this step, the aircraft identifier is related to an aircraft type, which is in turn, related to an electronic version of the aircraft procedures. The procedures may be presented on the display 316 (i.e., one of D1 . . . Dₙ) as a PDF document, an HTML document, or in any suitable format. The advisor may browse the document as needed in accordance with the operational scenario.

Once the displays are in place, the ground-based advisor is empowered to evaluate the real-time data and provide the aircrew with assistance via the voice communication channel. Referring to the examples provided in the Background Section, the ground-based advisor is well equipped by the present invention to provide advice during an instrument landing based on the simulated IPD. The present invention may also be used to directing the pilot to the nearest airfield during an emergency. The present invention may be used to provide the subscriber aircraft with an alternative flight path to avoid adverse weather conditions. The ground-based advisor may also relay certain aircraft procedures in the event of some other flight emergency, such as an equipment malfunction. As part of the process, the ground-based advisor may be in contact with an ATC or some other ground-based authority. GBCS 30 also provides the advisor with other information. For example, the ground-based advisor may retrieve and display a weather radar input corresponding to the flight path of the subscriber aircraft. The advisor may also obtain the latest weather forecast for the destination.

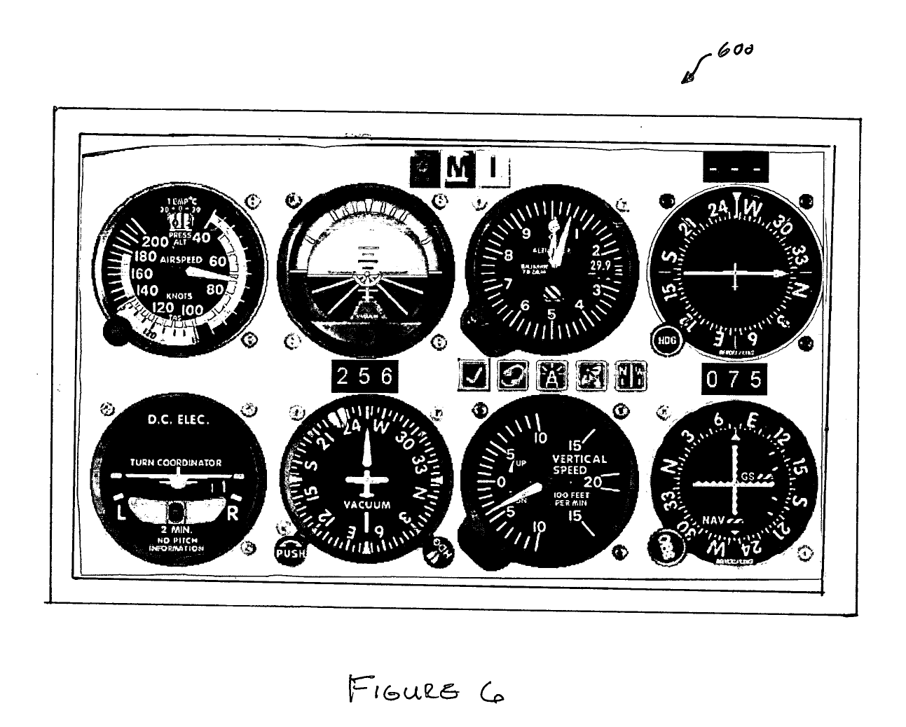

Referring to FIG. 6, an example of a simulated instrument panel display screen 600 in accordance with an embodiment of the present invention is disclosed. As noted previously, display screen 600 would be disposed on the display 316 (See FIG. 3). In the embodiment shown herein, the display is a replica of an analog IPD having multiple gauges for displaying airspeed, aircraft roll, altimeter readings, heading, pitch, etcetera. The present invention, of course, is not limited to IPDs of this type. The present invention may also replicate the flat panel display systems employed by more modem aircraft. In fact, the present invention may be easily programmed and configured to provide a digital image of any IPD in existence or may be any alphanumeric representation of the data.

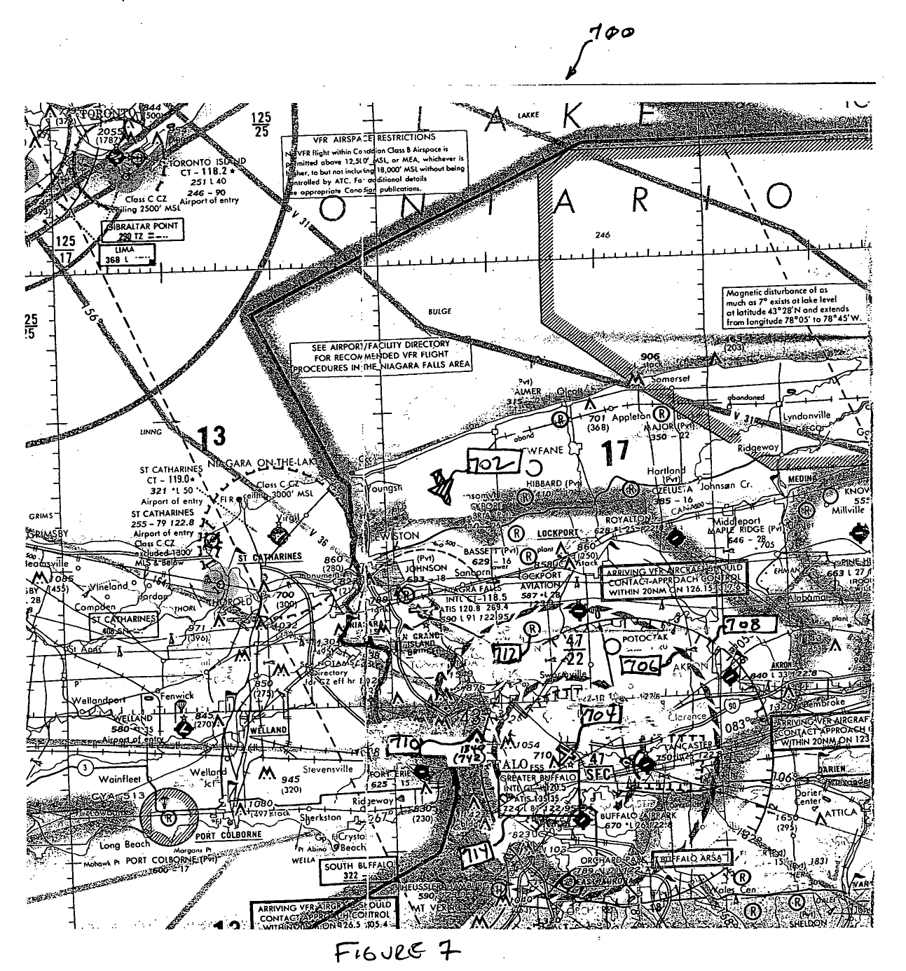

Referring to FIG. 7, an example of a mapping display screen 700 in accordance with an embodiment of the present invention is disclosed. In one embodiment, display 700 provides a sectional map corresponding to the location of the subscriber aircraft. As those of ordinary skill in the art will appreciate, a sectional map is for VFR flight only. As such, they feature landmarks that are visible from the air, such as railroads, lakes and rivers, especially prominent buildings, cities, power lines, and towers and other obstructions. Each Sectional Aeronautical Chart carries the name of a principal city within its coverage area. FIG. 7 provides a portion of the “Detroit Area” sectional. A terminal area chart is a detailed portion of a Sectional Map and functions in a manner similar to the way a city map shows a detailed part of a state map. The terminal chart is an expanded view of the terrain and aeronautical features in the vicinity of a major city.

In the example shown in FIG. 7, a digitized terminal area map is provided. Display screen 700 is constructed using a digital map that includes terrain features, such as lakes, roads, and other such information. The subscriber aircraft 702 is shown in the middle of display 700. Aircraft 702 is pointed in the direction that it is heading. The ground-based observer “sees” the terrain and the map symbols moving underneath aircraft symbol 702, which as noted above, is disposed in the center of the display 700. In one embodiment, the map is oriented such that north is pointed “up.”In another embodiment, the aircraft direction is up, i.e., points to the top of the display. Any suitable representation may be employed. Icons 704 identifying airports also appear on the sectional map 700. Airport icons 704 may be displayed in red if the airport or airfield is an uncontrolled field (no control tower). If the airport is a controlled field, icon 704 is displayed in blue. Note also that the airport symbol provides the layout of the airport as well. The dashed circle 706 identifies the Class D airspace in the proximity of airport 704. Compass rose 708 provides VHF omni-directional range (VOR) information. As those of ordinary skill in the art will appreciate, a VOR station broadcasts a VHF radio signal that encodes both the identity of the station and the angle to it. This information provides the pilot with a directional vector in the direction the aircraft is relative to the VOR station. This direction is commonly referred to as the radial. Symbol 710 (i.e., an inverted “V’) near airport symbol 704 represents an obstruction, such as a towers. In one embodiment, display 700 displays two numbers adjacent to the symbol. One number provides the obstruction's height above sea level. The second number provides the actual height in parenthesis. In the example provided, the tower is 1349 feet above sea level and 742feet above the ground level. When symbol 712 is disposed near an airport, it indicates that radar is available. Icon 714 may also be displayed. Icon 714 provides the Control Tower frequency information (CT) and the Automatic Terminal Information Service frequency (ATIS). Those skilled in the art will understand that the mapping data shown in FIG. 7 is not meant to be exhaustive, but is rather a representative example of what may be displayed.

As noted previously, workstation 314 integrates sensor data with the mapping information to superimpose a symbol 702, representing the subscriber aircraft, over the mapping data. In another embodiment, a cursor may be positioned over the symbol 702 by the work station operator. If the operator uses a mouse, or other such device, to “click” the symbol 702, additional data be displayed as a pop-up. For example, the pop-up may provide a call sign, altitude, speed, and/or any of the data provided via the data link.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A virtual copilot system comprising:
a subscriber aircraft copiloting system configured to obtain at least one aircraft sensor parameter from the aircraft, the copiloting system also being configured to transmit an aircraft identifier and the at least one aircraft sensor parameter via a subscriber data link on a real-time basis, the aircraft copiloting system also including two-way voice communications via a predetermined channel; and
a ground-based system comprising,
at least one ground communications device configured to receive the aircraft identifier and the at least one aircraft sensor parameter from the subscriber data link, the at least one communications device also being configured to support the two-way voice communications via the predetermined channel,
a computer system coupled to the at least one ground communications device, the computer system being configured to integrate cockpit instrument panel display data corresponding to the subscriber aircraft and the at least one sensor parameter to obtain a real-time representation of the subscriber aircraft instrument panel, and
at least one display coupled to the computer system and configured to display the real-time representation to a ground-based user.

2. The system of claim 1, wherein the subscriber aircraft copiloting system transmits a request for assistance by the subscriber data link.

3. The system of claim 1, wherein the subscriber aircraft copiloting system is coupled to a navigational system such that the at least one sensor parameter includes a subscriber positional data.

4. The system of claim 3, wherein the navigational system is selected from a group that includes a GPS receiver system, LORAN, or an inertial navigation system.

5. The system of claim 3, wherein the subscriber aircraft copiloting system transmits the positional data to the at least one ground communications device at least once a second.

6. The system of claim 1, wherein the at least one sensor parameter includes subscriber aircraft pitch attitude, subscriber aircraft roll attitude, subscriber aircraft airspeed, subscriber aircraft altitude, subscriber aircraft heading, and/or aircraft operating data.

7. The system of claim 6, wherein the at least one sensor parameter is transmitted to the at least one ground communications device at least once a second.

8. The system of claim 1, wherein the subscriber aircraft copiloting system further comprises:
a voice communications interface configured to accommodate aircrew microphone and speakers;
an avionics interface configured to obtain the at least one sensor parameter; and
at least one communications transceiver coupled to the voice communications interface and the avionics interface, the at least one communications transceiver being configured to support the subscriber data link and the predetermined channel.

9. The system of claim 8, wherein each of the at least one communications transceiver and the at least one ground communications device include a digital radio.

10. The system of claim 9, wherein the digital radio includes a data processor configured to format and transmit data and a voice processor, the digital radio providing a multiplexed signal including voice and sensor data.

11. The system of claim 8, wherein the at least one communications transceiver includes a data transmitter configured to support the subscriber data link.

12. The system of claim 8, wherein the at least one communications transceiver includes an analog radio transceiver configured to support the two-way voice communications via the predetermined channel.

13. The system of claim 8, wherein the at least one communications transceiver includes a satellite communications transceiver configured to support two-way voice communications via the predetermined channel.

14. The system of claim 1, wherein the ground-based system further comprises a subscriber aircraft database including at least one data structure stored thereon, each data structure including:
an aircraft identifier field including data corresponding to a subscriber aircraft identifier;
an aircraft type field including data representing an aircraft classification of the subscriber aircraft; and
cockpit instrument panel display field representing an image of the cockpit instrument panel display of an aircraft corresponding to the aircraft classification stored in the aircraft type field.

15. The system of claim 14, wherein the at least one sensor parameter includes subscriber aircraft position, subscriber aircraft pitch attitude, subscriber aircraft roll attitude, subscriber aircraft airspeed, subscriber aircraft altitude, subscriber aircraft heading, and/or engine or vehicle operating data.

16. The system of claim 15, wherein the at least one display includes a cockpit simulation display and wherein the computer system is further configured to:
retrieve the image of the cockpit instrument panel display of the subscriber aircraft from the subscriber aircraft database in accordance with the subscriber aircraft identifier;
integrate the subscriber aircraft position, the subscriber aircraft pitch attitude, the subscriber aircraft roll attitude, the subscriber aircraft airspeed, the subscriber aircraft altitude, and the subscriber aircraft heading into the image of the cockpit instrument panel display to obtain the real-time representation, wherein the real-time representation is periodically updated at a 1 Hz rate.

17. The system of claim 1, wherein the ground-based system further comprises a subscriber aircraft procedural database including at least one data structure stored thereon, each data structure including:
an aircraft identifier field including data corresponding to a subscriber aircraft identifier;
an aircraft type field including data representing an aircraft classification of the subscriber aircraft; and
at least one procedural data field corresponding to recommended aircraft procedures for an aircraft corresponding to the aircraft classification stored in the aircraft type field.

18. The system of claim 17, wherein the at least one display includes a subscriber aircraft procedural display, the computer system being configured to retrieve the recommended aircraft procedures for the subscriber aircraft from the subscriber aircraft procedural database, and wherein the computer system is further configured to provide the ground-based user with a browser application configured to navigate the recommended aircraft procedures for the subscriber aircraft.

19. The system of claim 1, wherein the ground-based system further comprises a geographical database including at least one data structure stored thereon, each data structure including:
a geographical position field including geographical position data; and
a map field including mapping data corresponding to the geographical position data stored in the geographical position field, the mapping data including terrain features, navigational aids, and airport location data.

20. The system of claim 19, wherein the at least one sensor parameter includes subscriber aircraft position, subscriber aircraft pitch attitude, subscriber aircraft roll attitude, subscriber aircraft airspeed, subscriber aircraft altitude, and subscriber aircraft heading.

21. The system of claim 20, wherein the at least one display includes a geographical situation display and wherein the computer system is further configured to:
retrieve the mapping data from the geographical data base corresponding to the subscriber aircraft position;
integrate the subscriber aircraft position and the subscriber aircraft heading into the mapping data to obtain the geographical situation display, the geographical situation display including at least a two-dimensional pictorial representation of the subscriber aircraft relative to the retrieved mapping data; and
repeat the step of integrating the subscriber aircraft position at a rate substantially equal to one (1) Hz, wherein the step of retrieving the mapping data is performed on an as-needed basis.

22. The system of claim 21, wherein the geographical situation display includes an alphanumeric representation of the subscriber aircraft ground track, and the subscriber aircraft altitude superimposed over the two-dimensional pictorial representation of the subscriber aircraft.

23. The system of claim 21, wherein the two-dimensional pictorial representation of the subscriber aircraft includes a graphical symbol having an aircraft heading indicator.

24. The system of claim 1, wherein the ground-based system further comprises:
at least one advisor communication interface associated with the at least one display, that at least one line interface being configured to accommodate ground-based user microphone and speakers;
at least one communications transceiver coupled to the at least one line interface, the at least one communications transceiver being configured to support the subscriber data link and the predetermined channel;
a telephony network interface selectively coupled to the at least one line interface; and
an interface selector coupled to the at least one line interface, the selector being configured to selectively connect the at least one line interface between the at least one communications transceiver and/or the telephony network interface.

25. The system of claim 24, wherein the at least one communications transceiver includes a radio, the radio including a data processor configured to receive the at least one sensor parameter from the subscriber aircraft and a voice processor coupled to the at least one line interface, the digital radio being configured to receive a multiplexed signal from the subscriber aircraft, the multiplexed signal providing voice and sensor data to the GBCS.

26. The system of claim 24, wherein the at least one communications transceiver includes a data transmitter configured to support the subscriber data link.

27. The system of claim 24, wherein the at least one communications transceiver includes an analog radio transceiver configured to support two-way voice communications via the predetermined channel.

28. The system of claim 24, wherein the at least one communications transceiver includes a satellite communications transceiver configured to support two-way voice communications via the predetermined channel.

29. A method for providing assistance from a ground-based system to an aircrew disposed on a subscriber aircraft, the subscriber aircraft being equipped with an aircraft instrumentation panel, the method comprising:
transmitting an aircraft identifier and at least one sensor parameter from the subscriber aircraft to the ground-based system on a real-time basis;
providing cockpit instrument panel data to the ground-based system, the cockpit instrument panel data corresponding to the aircraft identifier;
integrating the cockpit instrument panel data and the at least one sensor parameter to obtain a real-time status of the subscriber aircraft instrumentation panel in real-time;
displaying the real-time status to a ground-based user; and
establishing a two-way voice communication channel between the aircrew and the ground-based user, whereby the ground-based user provides co-piloting services to the aircrew via the two-way voice communication channel based on the displayed real-time status.

30. The method of claim 29, further comprising the step of transmitting a request for assistance from the subscriber aircraft to the ground-based system.

31. The method of claim 29, wherein the step of displaying further comprises:
retrieving an image of the cockpit instrument panel display of the subscriber aircraft;
integrating the at least one sensor parameter the image of the cockpit instrument panel display to obtain the real-time representation, the at least one sensor parameter including subscriber aircraft position, subscriber aircraft pitch attitude, subscriber aircraft roll attitude, subscriber aircraft airspeed, subscriber aircraft altitude, and subscriber aircraft heading, wherein the real-time representation is integrated at a rate of at least one (1) Hz.

32. The method of claim 29, wherein the step of displaying further comprises:
retrieving recommended aircraft procedures for the subscriber aircraft;
displaying the recommended aircraft procedures; and
providing the ground-based user with a browser application configured to navigate the recommended aircraft procedures for the subscriber aircraft.

33. The method of claim 29, wherein the at least one sensor parameter includes subscriber aircraft position, subscriber aircraft pitch attitude, subscriber aircraft roll attitude, subscriber aircraft airspeed, subscriber aircraft altitude, and subscriber aircraft heading.

34. The method of claim 29, wherein the step of displaying further comprises:
retrieving mapping data corresponding to a geographical area, the subscriber aircraft position being disposed in the geographical area;
integrating the subscriber aircraft position and the subscriber aircraft heading into the mapping data to obtain geographical situation display data, the geographical situation display data including at least a two-dimensional pictorial representation of the subscriber aircraft relative to the retrieved mapping data;
displaying the geographical situation display data to a ground-based user; and
repeating the steps of integrating and displaying at a 1 Hz rate, wherein the step of retrieving the mapping data is performed on an as-needed basis.

35. The method of claim 34, wherein the step of displaying includes providing an alphanumeric representation of the subscriber aircraft heading, the subscriber aircraft ground track, the subscriber aircraft airspeed, and the subscriber aircraft altitude superimposed over the two-dimensional pictorial representation of the subscriber aircraft.

36. The system of claim 34, wherein the two-dimensional pictorial representation of the subscriber aircraft includes a graphical symbol having an aircraft heading indicator.

37. The method of claim 29, wherein the step of transmitting an aircraft identifier is performed by establishing a digital data link between the subscriber aircraft and the ground-based system.

38. The method of claim 29, wherein the step of establishing a two-way voice communication channel between the aircrew and the ground-based user may be performed by way of a digital radio channel, an analog radio channel, or a satellite communications channel.

39. A subscriber aircraft copiloting system comprising:
an aircraft systems interface configured to obtain aircraft sensor parameters from the aircraft, the sensor parameters including a subscriber aircraft position, a subscriber aircraft pitch attitude, a subscriber aircraft roll attitude, a subscriber aircraft airspeed, a subscriber aircraft altitude, and/or a subscriber aircraft heading;
a data transmission facility configured to transmit an aircraft identifier and the aircraft sensor parameters to a ground-based station on a real-time basis via a subscriber data link, wherein the subscriber data link transmits the aircraft sensor parameters at a 1 Hz rate;
a voice communications system configured to provide two-way voice communications between an on-board user and a ground-based user via a predetermined channel.

40. A ground-based copiloting system comprising:
a ground-based communications system (GBCS) configured to receive an aircraft identifier and aircraft sensor parameters from a subscriber aircraft by way of a subscriber data link, the GBCS also being configured to provide voice communications between a ground-based user and a user aboard the subscriber aircraft via a predetermined channel;
a computer system coupled to the GBCS, the computer system being configured to integrate cockpit instrument panel display data corresponding to the subscriber aircraft and the aircraft sensor parameters to obtain a real-time representation of the subscriber aircraft instrument panel; and
at least one display coupled to the computer system and configured to display the real-time representation to the ground-based user.

41. The system of claim 40, wherein the at least one display includes a cockpit simulation display that integrates the subscriber aircraft position, the subscriber aircraft pitch attitude, the subscriber aircraft roll attitude, the subscriber aircraft airspeed, the subscriber aircraft altitude, and the subscriber aircraft heading into an image of the cockpit instrument panel display to obtain the real-time simulation, wherein the real-time representation is updated at a 1Hz rate.

42. The system of claim 40, wherein the at least one display includes a subscriber aircraft procedural display, the display providing recommended aircraft procedures for the subscriber aircraft to a ground-based user by way of a visual display.

43. The system of claim 40, wherein the at least one display includes a geographical situation display that integrates a subscriber aircraft position and a subscriber aircraft heading into geographical mapping data to obtain the geographical situation display, the geographical situation display including at a two-dimensional pictorial representation of the subscriber aircraft relative to the geographical mapping data, the geographical situation display being updated at a 1 Hz rate.

44. The system of claim 43, wherein the geographical situation display includes an alphanumeric representation of the subscriber aircraft airspeed, and the subscriber aircraft altitude superimposed over the two-dimensional pictorial representation of the subscriber aircraft.

45. The system of claim 43, wherein the two-dimensional pictorial representation of the subscriber aircraft includes a graphical symbol having an aircraft heading indicator.
